(19) United States
(12) Patent Application Publication
(10) Pub. No.: US 2004/0007021 A1
(43) Pub. Date: Jan. 15, 2004

(54) Covered roller for conveying glass

(76) Inventors: Masafumi Igo, Tokyo (JP); Masaaki Nakayama, Hamamatsu-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/615,785

(22) Filed: Jul. 10, 2003

(30) Foreign Application Priority Data
Jul. 11, 2002 (JP) 2002-202797

(51) Int. Cl. C03B 13/16; C03B 13/00

(52) U.S. Cl. 65/101; 65/370.1; 65/253

(57) ABSTRACT

A roller for use in plate glass manufacturing apparatus for making softened glass flow down like a belt from a melting furnace and hardening the softened glass meanwhile so as to work the softened glass into plate glass. The roller pinches the belt-like softened glass flowing down and moves the belt-like softened glass downward forcibly, or pinches the plate glass of the hardened belt-like softened glass and guides the plate glass downward. The roller includes a shaft longer than the full width of the belt-like softened glass or the plate glass, and pinching portions made of a heat-resistant material and provided to project over a predetermined width in positions of the shaft facing opposite end portions of the belt-like softened glass or the plate glass.

### BACKGROUND OF THE INVENTION

The present invention relates to a roller used in plate glass manufacturing apparatus for processing softened glass discharged from a melting furnace to flow down in belt-like shape into plate glass by hardening in its flow.

Manufacturing apparatus as shown in FIG. 5 is known as apparatus for manufacturing plate glass. In the illustrated plate glass manufacturing apparatus 100, softened glass 110 is discharged continuously from a slit 102 opened like a straight line in a melting furnace 101. The belt-like softened glass 110 discharged thus is flowed down, and cooled meanwhile to be hardened. Thus, plate glass is manufactured. In addition, in the plate glass manufacturing apparatus 100, the belt-like softened glass 110 is pinched between a pair of pull rollers 210 so that the belt-like softened glass 110 is fed downward forcibly. Further, under the pull rollers 210, backup rollers (not shown) are provided to be paired in the same manner as the pull rollers 210, so as to guide plate glass, which has already hardened but held at a high temperature, to a not-shown subsequent process (e.g. cutting process).

Each of the pull rollers 210, as shown in FIG. 6, has a cylindrical body in which a plurality of discs 212 made of a heat-resistant material are fitted to a shaft 211 made of metal over the substantially full length of the shaft 211, and fixed thereto by nuts 215 or the like while pressure is applied all over the discs 212 from their opposite ends so as to compress the discs 212 slightly. The belt-like softened glass 110 is pinched on the outer circumferential surfaces of the laminates of the discs 212. Further, a sheet-like molding including inorganic fiber or inorganic filler, binder or the like and punched out into a disc-like shape having an insertion hole for the shaft 211 is typically used as each of the discs 212.

As shown in FIG. 5, however, the pull rollers 210 come into contact with the belt-like softened glass 110 at a high temperature of typically about 800-900° C. because the pull rollers 210 are disposed in positions close to the slit 102 of the melting furnace 101. Therefore, the discs 212 forming the pull rollers 210 are contracted individually in their thickness direction so as to form a gap between adjacent ones of the discs 212. Thus, minute fiber pieces, binder and the like peel off and fall down from the discs 212, resulting in so-called “powder falling”.

Nowadays, in the plate glass manufacturing apparatus configured thus, the width of the belt-like softened glass 110 approaches 2 meters for supporting displays with a big screen. With the increase of the width, the laminated portions of the discs 212 in the pull rollers 210 become long (e.g. about 1.6 meters). In accordance with the elongation of the laminated portions, the number of the discs 212 used in each of the pull rollers 210 increases so that there can be produced a gap between adjacent ones of the discs easily, and hence power falling occurs in a comparatively short period. In addition, plate glass for use in plasma displays or liquid crystal displays coming into widespread use is requested to have higher quality. Thus, as soon as powder falling occurs, the production line is stopped, and most of plate glass having been manufactured till then is scrapped. At the same time, the rollers are exchanged for new ones.

In addition, rollers similar to the pull rollers 210 are typically used as the backup rollers. Plate glass with which the backup rollers are brought into contact is also at a high temperature of typically 300-400° C. Thus, the backup rollers also have a problem that they cause powder falling similarly though the powder falling is not as severe as that in the pull rollers 210.

Incidentally, the pull rollers 210 (and the backup rollers) as described above are generally called “disc rolls” because they are constituted by a laminate of a large number of discs 212, and the disc rolls are pull rolls 210 are regarded as synonymous with rollers in the invention.

### SUMMARY OF THE INVENTION

The invention was developed in consideration of such circumstances. An object of the invention is to provide a long-life roller in which powder falling is much rarer than in the conventional art and the roller exchange interval is longer.

In order to attain the foregoing object, the invention provides the following roller.

A roller for use in plate glass manufacturing apparatus for making softened glass flow down like a belt from a melting furnace and hardening the softened glass meanwhile so as to work the softened glass into plate glass, the roller pinching the belt-like softened glass flowing down and moving the belt-like softened glass downward forcibly, or pinching the plate glass of the hardened belt-like softened glass and guiding the plate glass downward, the roller including a shaft longer than a full width of the belt-like softened glass or the plate glass, and pinching portions made of a heat-resistant material and provided to project over a predetermined width in positions of the shaft facing opposite end portions of the belt-like softened glass or the plate glass.

Furthermore, the invention provides the following roller.

A roller for use in plate glass manufacturing apparatus for making softened glass flow down like a belt from a melting furnace and hardening the softened glass meanwhile so as to work the softened glass into plate glass, the roller pinching the belt-like softened glass flowing down and moving the belt-like softened glass downward forcibly, or pinching the plate glass of the hardened belt-like softened glass and guiding the plate glass downward, the roller including a pair of roller pieces each having a short shaft and a pinching portion made of a heat-resistant material and provided to project over a predetermined width on one end side of the short shaft, wherein the pair of roller pieces are disposed so that the pinching portions of the roller pieces face opposite end portions of the belt-like softened glass or the plate glass respectively.

In any one of the configurations, no disc is present between the pinching portions. Accordingly, separation between adjacent ones of the discs causing powder falling cannot occur in that portion. In addition, since the number of discs in each pinching portion is smaller, it is difficult to produce separation between the adjacent discs. Thus, it is more difficult than in the conventional art to produce contamination of plate glass due to powder falling, so that the yield in manufacturing plate glass can be enhanced. At the same time, the roller exchange interval becomes longer so that the life of the roller is extended.

### BRIEF DESCRIPTION OF THE DRAWINGS

FIG. 1 is a side view showing a first embodiment of a roller according to the invention.

FIG. 2 is a side view showing a second embodiment of the roller according to the invention.

FIG. 3 is a side view showing a third embodiment of a roller according to the invention.

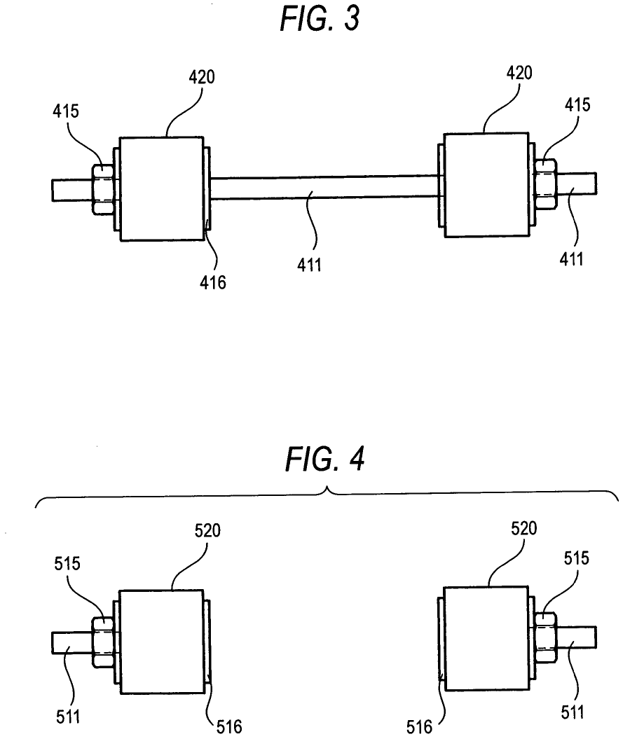

FIG. 2 is a side view showing a forth embodiment of the roller according to the invention.

FIG. 5 is a view schematically showing an example of plate glass manufacturing apparatus to which the rollers of a conventional art are applied.

FIG. 6 is a side view showing an example of a roller for use in the plate glass manufacturing apparatus in FIG. 5.

### DESCRIPTION OF THE PREFERRED EMBODIMENT

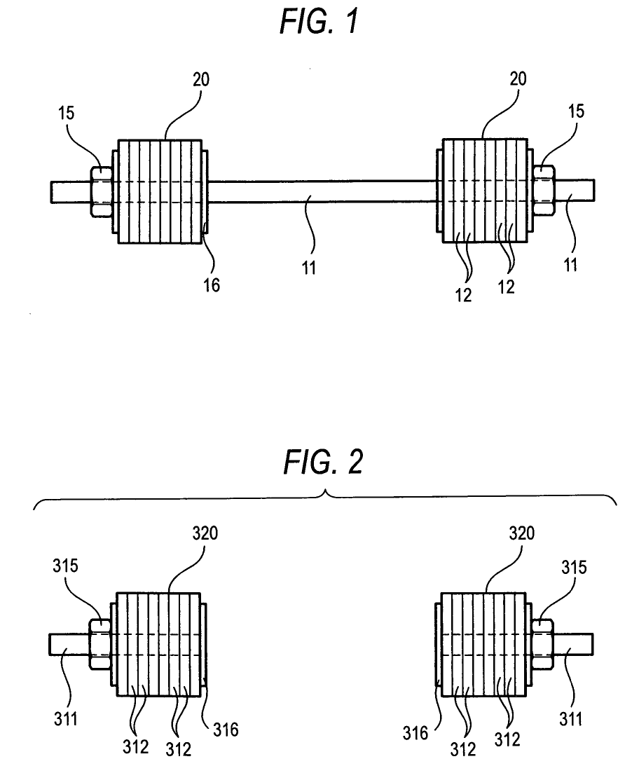

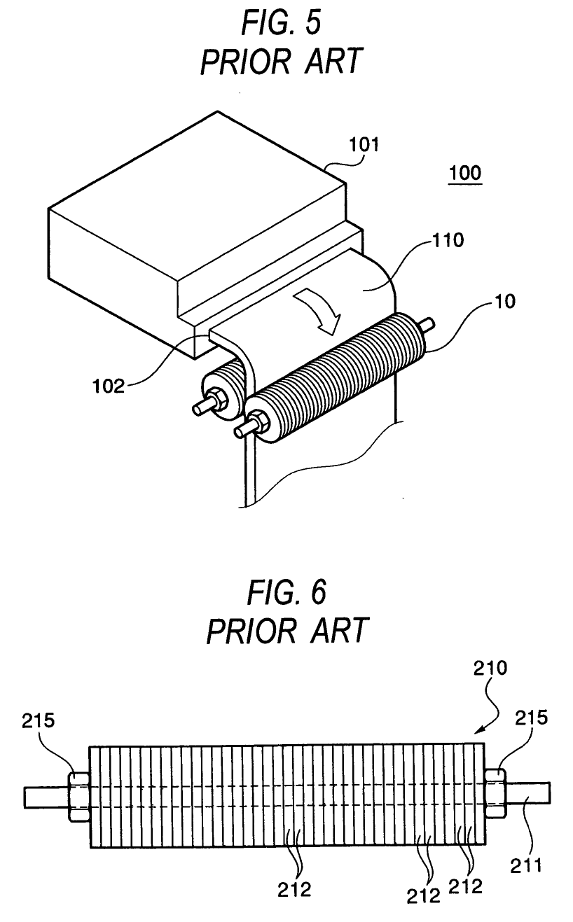

Embodiments of rollers according to the invention will be described below in detail with reference to FIGS. 1, 2, 3 and 4. Incidentally, FIG. 1 is a side view showing a roller according to a first embodiment of the invention. FIG. 2 is a side view showing a roller according to a second embodiment of the invention. FIG. 3 is a side view showing a roller according to a third embodiment of the invention. FIG. 4 is a side view showing a roller according to a forth embodiment of the invention.

As shown in FIG. 1, a roller of the first embodiment has a shaft 11 and pinching portions 20 each constituted by a laminate of a plurality of discs 12. The shaft 11 is a single rod-like product which is made of metal such as stainless steel and which is longer than the full width of belt-like softened glass. The shaft 11 may have a hollow allowing a suitable refrigerant (e.g. the air or water) to circulate.

In addition, a pair of toroidal flanges 16 are fixedly attached to the opposite ends of the shaft 11 so as to be positioned to be closer to the inside than the opposite ends of the belt-like softened glass correspondingly to the number of the laminated discs 12, respectively. The flanges 16 may be formed out of the same material as the shaft 11. Then, a predetermined number of discs 12 are fitted to one end portion of the shaft 11 with one of the flanges 16 as their inside end portion. Similarly, discs 12 are fitted to the other end portion by use of the other flange 16. The outside end of the discs 12 on each end of the shaft 11 is fixed by a nut 15 or the like. Thus, the pinching portions 20 are formed. Incidentally, the pinching portions 20 are preferably chamfered in their edge portions so as to be prevented from being damaged.

The discs 12 may be equal to those used in the roller of the conventional art. That is, a sheet-like molding including inorganic fiber or inorganic filler, binder or the like and punched out into a disc-like shape having a predetermined outer diameter and an insertion hole for the shaft 11 is used as each of the discs 12. Ceramic fiber such as alumina fiber, silica fiber or silica-alumina fiber is typically used as the inorganic fiber. Alumina particles, kibushi clay, kaolin particles, mica particles, or the like, is typically used as the inorganic filler. Inorganic binder such as silica sol or alumina sol, or organic binder such as acrylic emulsion or alpha-phased starch paste is typically used as the binder. Further, the density of the discs 12 is typically about 0.8-1.7 g/cm3.

In addition, after the discs 12 are fitted to the shaft 11, the nuts 15 are fastened to compress the discs 12. Thus, the discs 12 are fixed to the shaft 11 in pressure contact therewith. The number of the discs 12 and the compression rate there of may be set desirably in consideration of the material composition of the discs 12, the width and the outer diameter of the pinching portions 20, and so on.

As shown in FIG. 2, a roller of the second embodiment has a configuration in which the shaft 11 between the pair of left and right pinching portions 20 has been removed from the roller of the first embodiment. That is, the roller of the second embodiment is configured as follows. A pair of roller pieces are disposed to be opposite to each other correspondingly to the places where the pinching portions 20 of the roller of the first embodiment should be formed. In each of the roller pieces, a predetermined number of discs 312 are fitted to a short shaft 311 having a flange 316 fixedly attached to one end thereof while the other end is fixed by a nut 315 or the like, so that the pinching portion 320 is formed.

Incidentally, in the roller of the second embodiment, the pair of roller pieces have to be disposed to place the axes of their shafts 311 on the same level, and the roller pieces have to be synchronized with each other when they are rotated. Positioning or synchronously rotating the roller pieces thus can be performed easily in accordance with the related art by those skilled in the art.

In the rollers of the first and second embodiments configured thus, there is no disc 12, 312 between the pair of pinching portions 20, 320. Accordingly, there is no fear that powder falling occurs in that portion. Thus, the probability of contamination of belt-like softened glass or plate glass is reduced. As a result, the roller exchange interval is prolonged.

The rollers according to the invention can be subject to various modifications. For example, as shown in FIG. 3 and 4, the pinching portions 420, 520 may be formed out of moldings 420, 520 made of a heat-resistant material, in stead of the laminates of the discs. When the pinching portions are formed out of molding bodies 420, 520, separation of the discs from each other can be avoided in the pinching portions so that powder falling can be reduced further. In addition, the work of fastening the discs can be omitted so that the manufacturing work can be simplified.

As described above, according to the invention, it is possible to provide a long-life roller in which powder falling is reduced.

What is claimed is:

1. A roller, used in plate glass manufacturing apparatus for processing softened glass discharged from a melting furnace to flow down in belt-like shape into plate glass by hardening in its flow, for pinching and feeding the belt-like softened glass or for pinching and guiding the plate glass, comprising:
a shaft longer than a full width of the glass, and two pinching portions disposed on the shaft and made of a heat resistant material,
wherein each pinching portion is located on a position for pinching a respective side end portion of the glass.

2. A roller according to claim 1, wherein each of the pinching portions includes a plurality of discs made of a heat-resistant material and laminated to one another.

3. A roller according to claim 1, wherein each of the pinching portions is a molding body made of a heat-resistant material.

4. A roller, used in plate glass manufacturing apparatus for processing softened glass discharged from a melting furnace to flow down in belt-like shape into plate glass by hardening in its flow, for pinching and feeding the belt-like softened glass or for pinching and guiding the plate glass, comprising:
a pair of roller pieces each having a short shaft and
a pinching portion made of a heat resistant material and disposed on one end side of the short shaft,
wherein the pair of roller pieces are located so that the pinching portions of the roller pieces pinch a respective side end portions of the glass.

5. A roller according to claim 4, wherein each of the pinching portions includes a plurality of discs made of a heat-resistant material and laminated to one another.

6. A roller according to claim 4, wherein each of the pinching portions is a molding body made of a heat-resistant material.

7. A plate glass manufacturing apparatus, for processing softened glass discharged from a melting furnace to flow down in belt-like shape into plate glass by hardening in its flow, the glass is fed or guided by a roller in the apparatus,
wherein the roller comprises a shaft longer than a full width of the glass, and two pinching portions disposed on the shaft and made of a heat resistant material each located on a position for pinching a respective side end portion of the glass.

8. A plate glass manufacturing apparatus, for processing softened glass discharged from a melting furnace to flow down in belt-like shape into plate glass by hardening in its flow, the glass is fed or guided by a roller in the apparatus,
wherein the roller comprises a pair of roller pieces each having a short shaft and a pinching portion made of a heat resistant material and disposed on one end side of the short shaft, and
the pair of roller pieces are located so that the pinching portions of the roller pieces pinch a respective side end portions of the glass.
